(19) United States
(12) Patent Application Publication
(10) Pub. No.: US 2014/0331657 A1
(43) Pub. Date: Nov. 13, 2014

(54) CATALYST WARMING-UP CONTROL APPARATUS FOR VEHICLE

(71) Applicant: DENSO CORPORATION, Kariya-city (JP)

(72) Inventors: Noriaki IKEMOTO, Kariya-city (JP); Takeshi HARADA, Nagoya-city (JP)

(73) Assignee: DENSO CORPORATION, Kariya-city (JP)

(21) Appl. No.: 14/268,707

(22) Filed: May 2, 2014

(30) Foreign Application Priority Data
May 9, 2013 (JP) 2013-99154

(51) Int. Cl. F02M 27/02

(52) U.S. Cl. CPC F02M 27/02
USPC 60/303

(57) ABSTRACT

A vehicle includes an internal combustion engine, a generator driven by a power of the internal combustion engine, and an electrically heated catalyst purifying an exhaust gas of the internal combustion engine. A catalyst warming-up control apparatus applied to the vehicle includes a catalyst warming-up control portion executing a catalyst warming-up control in which the generator is driven by the power of the internal combustion engine to generate electricity, and a generated electric power of the generator is supplied to the electrically heated catalyst to energize and heat the electrically heated catalyst, in a reduction time period where an engine speed is reduced.

### CROSS REFERENCE TO RELATED APPLICATION

This application is based on Japanese Patent Application No. 2013-99154 filed on May 9, 2013, the disclosure of which is incorporated herein by reference.

### TECHNICAL FIELD

The present disclosure relates to a catalyst warming-up control apparatus for a vehicle provided with an electrically heated catalyst purifying an exhaust gas of an internal combustion engine.

### BACKGROUND

JP-2009-227038A discloses that an electrically heated catalyst which can be heated by a battery is used as a catalyst for purifying an exhaust gas of an internal combustion engine, in a hybrid vehicle provided with the internal combustion engine and a motor generator (MG) as power sources of the hybrid vehicle. According to JP-2009-227038A, when the hybrid vehicle reduces speed, the MG is driven by a power of wheels to generate electricity. The electricity (regenerative electric power) generated by the MG is supplied to the electrically heated catalyst to energize and heat the electrically heated catalyst or is supplied to charge the battery. Therefore, the regenerative electric power can be efficiently used.

JP-2009-227038A discloses a technology that a mechanical energy of when the hybrid vehicle reduces speed is converted to an electric energy by the MG to energize and heat the electrically heated catalyst. Therefore, when the electrically heated catalyst is energized to be heated while the hybrid vehicle is stopped, only an electric power of the battery is supplied to the electrically heated catalyst. Then, the electric power of the battery increases, and an energy efficiency of the hybrid vehicle may deteriorate.

### SUMMARY

It is an object of the present disclosure to provide a catalyst warming-up control apparatus which can improve an energy efficiency of a vehicle provided with an electrically heated catalyst.

According to an aspect of the present disclosure, a vehicle includes an internal combustion engine, a generator driven by a power of the internal combustion engine, and an electrically heated catalyst purifying an exhaust gas of the internal combustion engine. A catalyst warming-up control apparatus applied to the vehicle includes a catalyst warming-up control portion executing a catalyst warming-up control in which the generator is driven by the power of the internal combustion engine to generate electricity, and a generated electric power of the generator is supplied to the electrically heated catalyst to energize and heat the electrically heated catalyst, in a reduction time period where an engine speed is reduced.

According to the above configuration, the catalyst warming-up control is executed in the reduction time period. Therefore, a mechanical energy of when the engine speed is reduced can be converted to an electric energy by the generator to energize and heat the electrically heated catalyst, and the mechanical energy can be efficiently used. Even though the vehicle is stopped, when the engine speed is reduced, the mechanical energy of the internal combustion engine can be converted to the electric energy by the generator to energize and heat the electrically heated catalyst. Therefore, an electric power of a battery can be reduced, and the mechanical energy of the vehicle can be efficiently improved. Further, the electrically heated catalyst can be energized and heated without respect to a charging state of the battery.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a control system of a vehicle, according to an embodiment of the present disclosure;

FIG. 2 is a flowchart showing a catalyst warming-up control routine; and

FIG. 3 is a time chart showing an example of executing a catalyst warming-up control.

### DETAILED DESCRIPTION

Embodiments of the present disclosure will be described hereafter. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, referring to drawings, an embodiment of the present disclosure will be described.

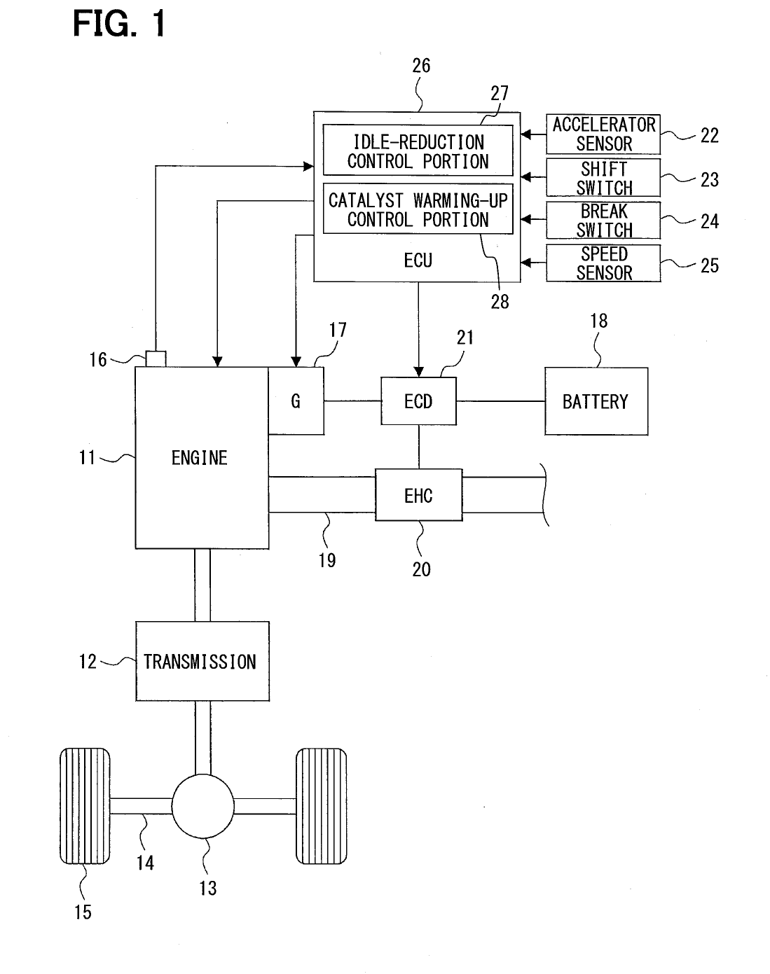

First, referring to FIG. 1, a configuration of a control system of a vehicle will be described.

The control system includes an engine 11 corresponding to an internal combustion engine, a transmission 12, a differential gear mechanism 13, an axle 14, and a wheel 15. A power of an output shaft of the engine 11 is transmitted to the transmission 12. In this case, the output shaft of the engine 11 corresponds to a crank shaft. A power of an output shaft of the transmission 12 is transmitted to the wheel 15 via the differential gear mechanism 13 and the axle 14. In other words, the transmission 12 is provided in a power transmission path of the engine 11 so as to transmit the power of the engine 11 to the wheel 15.

A crank angle sensor 16 outputting a pulse signal every time that the crank shaft rotates for a predetermined crank angle is mounted to the engine 11. A crank angle or an engine speed is detected based on an output signal of the crank angle sensor 16.

The control system further includes a generator (G) 17 driven by the power of the engine 11, and a battery 18. The generator 17 charges the battery 18 by a generated electric power of the generator 17. The generator 17 may be an alternator or a motor generator. The engine 11 and the generator 17 are connected to each other via a belt-pulley mechanism to transmit a power.

The control system further includes an exhaust pipe 19 and an electrically heated catalyst (EHC) 20. The EHC 20 can be electrically heated as a catalyst purifying an exhaust gas, and is disposed in the exhaust pipe 19. The EHC 20 is constructed by a base member and a catalyst coating member which are not shown. The base member is formed by a conductive resistance such as a conductive ceramic or a heat resistant stainless. The catalyst coating member covers the base member. The EHC 20 energizes the base member by a power supplied from the battery 18 or the generator 17, such that the base member is heated as a heater. In addition, the EHC 20 may further include another heater different from the base member.

The control system further includes an energization control device (ECD) 21 controls an energization power of the EHC 20. In this case, the energization power of the EHC 20 corresponds to a power supplied to the base member of the EHC 20. The energization control device 21 includes an energization-power control portion which is not shown. The energization-power control portion includes a switching circuit. The energization-power control portion converts and smooths a voltage of a power supplied from the battery 18 or the generator 17, and transmits to the EHC 20.

The control system further includes an accelerator sensor 22, a shift switch 23, a break switch 24, a speed sensor 25, and an ECU 26. The accelerator sensor 22 detects an accelerator position corresponding to an operating amount of an accelerator pedal. The shift switch 23 detects an operating position of a shift lever. The break switch 24 may correspond to a break sensor detecting an operating amount of a break. The speed sensor 25 detects a vehicle speed. Outputs of the above sensors and switches are transmitted to the ECU 26. The ECU 26 mainly constructed by a microcomputer controls the engine 11 according to an operating state of the vehicle, and controls the generated electric power of the generator 17. Further, the ECU 26 controls the energization control device 21 to control the energization power of the EHC 20.

According to the present embodiment, the ECU 26 is constructed by one control unit. However, for example, the ECU 26 may be constructed by an engine ECU, a power-generating ECU, and an energization ECU, and may transmit and receive control signals or data signals between the above ECUs. In this case, the engine ECU controls the engine 11, the power-generating ECU controls the generator 17, and the energization ECU controls the energization control device 21.

The ECU 26 includes an idle-reduction control portion 27 executing an idle reduction control by executing an idle-reduction control routine that is not shown. In this case, the idle reduction control corresponds to an engine automatic stop and start control. In the idle reduction control, when an automatic stop condition that a driver stops the vehicle or reduces the vehicle speed while the engine 11 is operating is met, the engine 11 is automatically stopped. When the automatic stop condition is met, an automatic stop request is generated. Then, when a restart condition that the driver starts the vehicle or accelerates the vehicle speed while the engine 11 is automatically stopped or is in the idle reduction is met, the engine 11 is automatically restarted. When the restart condition is met, a restart request is generated. According to the present embodiment, the automatic stop condition corresponds to a predetermined automatic stop condition, and the restart condition corresponds to a predetermined restart condition.

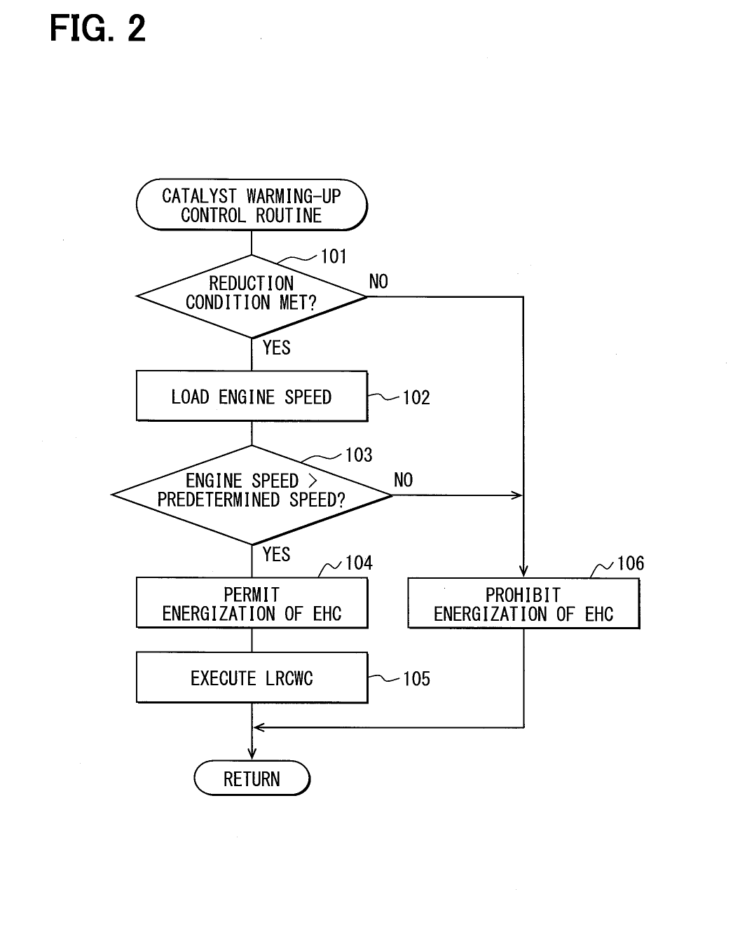

According to the present embodiment, the ECU 26 executes a catalyst warming-up control routine as shown in FIG. 2 to execute a catalyst warming-up control. In the catalyst warming-up control, the generator 17 is driven by the power of the engine 11 to generate electricity, and the generated electric power is supplied to the EHC 20 to energize and heat the EHC 20, in a reduction time period where the engine speed is reduced. In this case, the catalyst warming-up control corresponds to a low-rotation catalyst warming-up control (LRCWC). Thus, a mechanical energy of when the engine speed is reduced can be converted to an electric energy by the generator 17 to energize and heat the EHC 20, and the mechanical energy can be efficiently used.

According to the present embodiment, the LRCWC is executed in the reduction time period where the engine speed is reduced due to a fuel cut for terminating a fuel injection of the engine 11. In other words, the LRCWC is executed in a time period from a time point that the fuel cut is executed to a time point that the engine 11 is stopped. Further, the LRCWC is executed in the reduction time period where the engine speed is reduced due to an automatic stop of the engine 11 in the idle reduction control. In other words, the LRCWC is executed in a time period from a time point that the idle reduction control is executed to a time point that the engine 11 is stopped. Furthermore, the LRCWC is executed in the reduction time period where the engine speed is reduced due to a gear change (e.g., a shift up) of the transmission 12.

Hereafter, the catalyst warming-up control routine executed by the ECU 26 will be described.

The catalyst warming-up control routine is repeatedly executed at a predetermined period while the ECU 26 is energized (e.g., an ignition switch is turned on). The catalyst warming-up control routine corresponds to a catalyst warming-up control portion 28 of the ECU 26 as shown in FIG. 1.

At 101, the ECU 26 determines whether a reduction condition is met. For example, the reduction condition includes conditions (i), (ii), and (iii). The ECU 26 determines whether the reduction condition is met by determining whether one of the conditions (i), (ii), and (iii) is met.

When a fuel cut request of the engine 11 is generated, the condition (i) is met.

When the automatic stop condition is met, the condition (ii) is met.

When a shift up request of the transmission 12 is generated, the condition (iii) is met.

When at least one of the conditions (i), (ii), and (iii) is met, the reduction condition is met. When none of the conditions (i), (ii), and (iii) is met, the reduction condition is not met.

When the ECU 26 determines that the reduction condition is not met at 101, the ECU 26 proceeds to 106. At 106, the ECU 26 prohibits an energization of the EHC 20, and terminates the present routine.

When the ECU 26 determines that the reduction condition is met at 101, the ECU 26 proceeds to 102. At 102, the ECU 26 loads the engine speed. At 103, the ECU 26 determines whether the engine 11 is operating in the reduction time period by determining whether the engine speed is greater than a predetermined speed.

For example, when the engine speed is reduced due to the fuel cut or the automatic stop, the ECU 26 determines whether the engine 11 is operating in the reduction time period by determining whether the engine speed is greater than zero. When the engine speed is reduced due to the shift up of the transmission 12, the ECU 26 determines whether the engine 11 is operating in the reduction time period by determining whether the engine speed is greater than a rotational speed generated according to the vehicle speed and a transmission level after the shift up.

When the ECU 26 determines that the engine speed is greater than the predetermined speed at 103, the ECU 26 determines that the engine 11 is operating in the reduction time period, and proceeds to 104. At 104, the ECU 26 permits the energization of the EHC 20, such that the generated electric power of the generator 17 is able to be supplied to the EHC 20.

At 105, the ECU 26 executes the LRCWC. In the LRCWC, the generator 17 is driven by the power of the engine 11 to generate electricity, and the generated electric power is supplied to the EHC 20 to energize and heat the EHC 20, in the reduction time period. In this case, the generated electric power may be greater than that of when the EHC 20 is deenergized.

When the ECU 26 determines that the engine speed is less than or equal to the predetermined speed at 103, the ECU 26 determines that the reduction time period is completed, and proceeds to 106. At 106, the ECU 26 prohibits the energization of the EHC 20, and terminates the present routine.

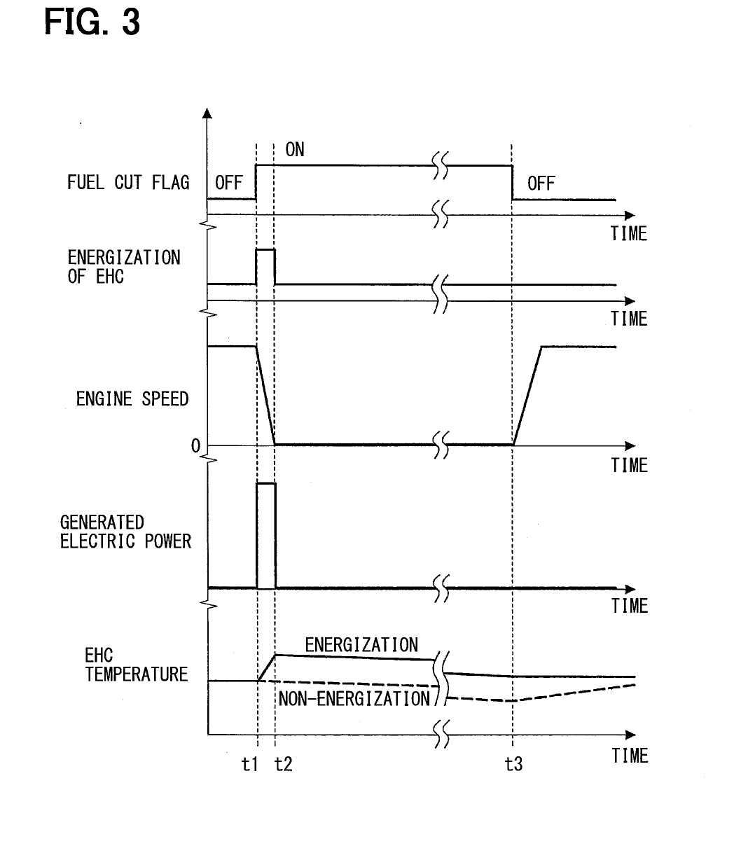

Next, referring to a time chart shown in FIG. 3, an example of executing the catalyst warming-up control will be described.

The fuel cut is executed at a time point t1 that the fuel cut request is generated and a fuel cut flag is turned on, while the engine 11 is operating. Therefore, since a combustion of the engine 11 is stopped, the engine 11 is stopped after the engine speed is reduced.

The ECU 26 permits the energization of the EHC 20 at the time point t1, and executes the LRCWC in the reduction time period. Therefore, a temperature of the EHC 20 is increased. The temperature of the EHC 20 corresponds to an EHC temperature.

A power generation of the generator 17 is terminated according to a stop of the engine 11, at a time point t2 that the engine speed is reduced to zero. The ECU 26 prohibits the energization of the EHC 20 and terminates the LRCWC, at the time point t2.

The fuel cut is completed at a time point t3 that a fuel cut complete request is generated and the fuel cut flag is turned off. In other words, the fuel injection is restarted at the time point t3. In this case, the time point t3 corresponds to a time point that a fuel injection restart request is generated and the fuel cut flag is turned off. Then, the engine 11 starts, and the engine speed rises.

According to the present embodiment, the LRCWC is executed in the reduction time period. Therefore, the mechanical energy of when the engine speed is reduced can be converted to the electric energy by the generator 17 to energize and heat the EHC 20, and the mechanical energy can be efficiently used. Even though the vehicle is stopped, when the engine speed is reduced, the mechanical energy of the engine 11 can be converted to the electric energy by the generator 17 to energize and heat the EHC 20. Therefore, an electric power of the battery 18 can be reduced, and the mechanical energy of the vehicle can be efficiently improved. Further, The EHC 20 can be energized and heated without respect to a charging state of the battery 18.

According to the present embodiment, since the LRCWC is executed in the reduction time period where the engine speed is reduced due to the fuel cut of the engine 11, the mechanical energy of when the engine speed is reduced according to the fuel cut can be efficiently used. As shown in FIG. 3, since the combustion of the engine 11 is stopped and a heating of the EHC 20 executed by an exhaust heat is stopped while the fuel cut is executed, the temperature of the EHC 20 is gradually decreased. According to the present embodiment, the temperature of the EHC 20 can be temporarily increased by energizing and heating the EHC 20 in the reduction time period where the engine speed is reduced due to the fuel cut. Therefore, as shown in FIG. 3, the EHC temperature of when the EHC 20 is energized while the engine speed is reduced can be greater than the EHC temperature of when the EHC 20 is deenergized while the engine speed is reduced, at the time point t3 that the fuel cut is completed or the fuel injection is restarted, and a purification rate of the exhaust gas can be improved.

According to the present embodiment, the LRCWC is executed in the reduction time period where the engine speed is reduced due to the automatic stop of the engine 11 in the idle reduction control. Therefore, the mechanical energy of when the engine speed is reduced according to the automatic stop of the engine 11 can be efficiently used. Further, since the combustion of the engine 11 is stopped and the heating of the EHC 20 executed by the exhaust heat is stopped while the engine 11 is automatically stopped or in the idle reduction, the temperature of the EHC 20 is gradually decreased. According to the present embodiment, the temperature of the EHC 20 can be temporarily increased by energizing and heating the EHC 20 in the reduction time period where the engine speed is reduced due to the automatic stop of the engine 11. Therefore, the EHC temperature of when the EHC 20 is energized while the engine speed is reduced can be greater than the EHC temperature of when the EHC 20 is deenergized while the engine speed is reduced, at the time point t3 that the engine 11 is restarted, and a purification rate of the exhaust gas can be improved.

According to the present embodiment, the LRCWC is executed in the reduction time period where the engine speed is reduced due to the gear change of the transmission 12. Therefore, the mechanical energy of when the engine speed is reduced according to the gear change of the transmission 12 can be efficiently used. Since the temperature of the EHC 20 can be increased by energizing and heating the EHC 20 in the reduction time period where the engine speed is reduced due to the gear change of the transmission 12, the EHC temperature can be increased after the gear change, and the purification rate of the exhaust gas can be improved.

According to the above embodiment, the LRCWC is executed in the reduction time period where the engine speed is reduced due to the fuel cut of the engine 11, in the reduction time period where the engine speed is reduced due to the automatic stop of the engine 11, and in the reduction time period where the engine speed is reduced due to the gear change of the transmission 12. However, it is not limited to the above reduction time periods. For example, the LRCWC may be executed in two of the above reduction time periods or in one of the above reduction time periods. Further, the LRCWC may be executed in other time periods where the engine speed is reduced.

According to the above embodiment, in the LRCWC, the generated electric power of the generator 17 is supplied to the EHC 20. However, the generated electric power of the generator 17 may be supplied to both the EHC 20 and the battery 18. In this case, the generated electric power is supplied to the battery 18 to charge the battery 18. Alternatively, both the generated electric power of the generator 17 and the electric power of the battery 18 may be supplied to the EHC 20.

According to the above embodiment, the EHC 20 is connected to the generator 17 and the battery 18. However, the EHC 20 may be not connected to the battery 18.

According to the above embodiment, the catalyst warming-up control apparatus is applied to the vehicle provided with the engine 11 as a power source. However, the catalyst warming-up control apparatus may be applied to a hybrid vehicle provided with an engine and a motor generator as power sources.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A catalyst warming-up control apparatus for a vehicle including an internal combustion engine, a generator driven by a power of the internal combustion engine, and an electrically heated catalyst purifying an exhaust gas of the internal combustion engine, the catalyst warming-up control apparatus comprising:
a catalyst warming-up control portion executing a catalyst warming-up control in which the generator is driven by the power of the internal combustion engine to generate electricity, and a generated electric power of the generator is supplied to the electrically heated catalyst to energize and heat the electrically heated catalyst, in a reduction time period where an engine speed is reduced.

2. The catalyst warming-up control apparatus according to claim 1, wherein
the catalyst warming-up control portion executes the catalyst warming-up control, in the reduction time period where the engine speed is reduced due to a fuel cut for terminating a fuel injection of the internal combustion engine.

3. The catalyst warming-up control apparatus according to claim 1, further comprising:
an idle-reduction control portion executing an idle reduction control in which (i) the internal combustion engine is automatically stopped when a predetermined automatic stop condition is met, and (ii) the internal combustion engine is automatically restarted when a predetermined restart condition is met, wherein
the catalyst warming-up control portion executes the catalyst warming-up control, in the reduction time period where the engine speed is reduced due to an automatic stop of the internal combustion engine in the idle reduction control.

4. The catalyst warming-up control apparatus according to of claim 1, wherein
the catalyst warming-up control portion executes the catalyst warming-up control, in the reduction time period where the engine speed is reduced due to a gear change of a transmission provided in a power transmission path of the internal combustion engine.
